(19) United States
(12) Patent Application Publication
(10) Pub. No.: US 2013/0278715 A1
(43) Pub. Date: Oct. 24, 2013

(54) SYSTEM AND METHOD FOR DISCREETLY COLLECTING 3D IMMERSIVE/PANORAMIC IMAGERY

(71) Applicants: Mark Nutsch, Leavinworth, KS (US); Marion Barwig, Tucson, AZ (US); Bryan Anderson, Lucas, TX (US)

(72) Inventors: Mark Nutsch, Leavinworth, KS (US); Marion Barwig, Tucson, AZ (US); Bryan Anderson, Lucas, TX (US)

(21) Appl. No.: 13/841,535

(22) Filed: Mar. 15, 2013

Related U.S. Application Data
(60) Provisional application No. 61/612,165, filed on Mar. 16, 2012.

(51) Int. Cl. H04N 5/232

(52) U.S. Cl. CPC H04N 5/23238
USPC 348/38

(57) ABSTRACT

According to an embodiment of the disclosure, a system for discretely capturing data comprises a concealing structure and two or more cameras hidden within the concealing structure. The two or more cameras each having one or more sensors configured to collect imagery data. The imagery data includes data configured to construct one or more images. According to particular embodiments, the concealing structure is part of a vehicle, Additionally, according to particular embodiments, the two or more cameras are laterally offset from one another. Yet additionally, according to further embodiments, multiple sets of a plurality of laterally offset cameras are provided.

### TECHNICAL FIELD

The present disclosure is directed, in general, to imagery capturing systems, and more specifically, to a system and method for discreetly collecting 3D immversive, High Definition (HD), Standard Definition (SD) or Infra-Red (IR) panoramic imagery from a distributed, concealed or embedded camera system array.

### BACKGROUND

A variety of image capturing systems exist. One popular image capturing system is a device employed by Google to prepare its Street View maps. This device mounts camera in a ball-like configuration on top of a mast several feet long. Such a device often invokes strange looks from viewers of the device as captured in the Street View map images, themselves.

### SUMMARY

According to an embodiment of the disclosure, a system for discretely capturing data comprises a concealing structure and two or more cameras hidden within the concealing structure. The two or more cameras each having one or more sensors configured to collect imagery data. The imagery data includes data configured to construct one or more images. According to particular embodiments, the concealing structure is part of a vehicle. Additionally, according to particular embodiments, the two or more cameras are laterally offset from one another. Yet additionally, according to further embodiments, multiple sets of a plurality of laterally offset cameras are provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “server” means any device, system or part thereof that controls at least one operation, such a device may be implemented in hardware, firmware or software, or some combination of at least two of the same. It should be noted that the functionality associated with any particular server may be centralized or distributed, whether locally or remotely.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a drawing illustrative of a system for discreetly collecting 3D immersive, HD, SD or IR panoramic imagery by a distributed, concealed or embedded camera system array, that may be utilized by various embodiments of the disclosure;

FIG. 1B is a simplified block diagram of one embodiment of a distributed concealed or embedded imagery capturing system that may be utilized by various embodiments of the disclosure;

FIG. 2 is a simplified diagram of one embodiment of the exterior of a vehicle roof rack operable to carry out discreet capturing of imagery by a distributed, concealed or embedded system array, that may be utilized by various embodiments of the disclosure;

FIG. 3A is a simplified diagram of one embodiment of the interior of a vehicle roof rack configured to provide for the discreet capturing of imagery, by a distributed, concealed or embedded camera system array, which may be utilized by various embodiments of the disclosure;

FIG. 3B is a diagram of the cross section of metal, plastic or fiberglass tubing used in a vehicle roof rack operable to carry out discreet capturing of imagery, which may be utilized by various embodiments of the disclosure;

FIG. 4 is an additional depiction of a roof rack that may be utilized for a discreet, distributed, concealed or embedded camera system array by various embodiments of the disclosure;

FIG. 5 illustrates an angle of view depiction of one embodiment of a distributed, concealed or embedded imagery capturing system, according to an embodiment of the disclosure;

FIG. 6 illustrates a wiring system layout of one embodiment of an imagery capturing system, according to an embodiment of the disclosure;

FIG. 7 is a depiction of various angles of a distributed camera system array and the camera's housing for use in one embodiment of an imagery capturing system, according to an embodiment of the disclosure; and

FIG. 8 depicts an embodiment of a computing device that may be used in connection with embodiments of the disclosure to carry out any of the above-referenced functions and/or serve as a computing device for processing and storing imagery captured by the system.

### DETAILED DESCRIPTION

The FIGURES, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

Recently, imagery capturing systems have made possible the ability to capture pictures, video, Global Positioning System (GPS) coordinate information, camera facing direction, or any combination of data by using cameras and other devices capable of generating panoramic views of its surroundings. Known imagery capturing systems are comparatively large and bulky, with cameras that are plainly visible to anyone seeing the imagery capturing system as it goes about capturing data. For example, these systems often include one or more fairly large camera housings containing a number of cameras that are mounted on the roofs of vehicles for obtaining a panoramic view.

A variety of uses exist for this type of imagery ranging from consumer mapping applications such as Google's Street View, to military uses for surveying unfamiliar or unfriendly terrain to aid in route mapping, mission planning, and creating 3D immersive imagery. For most applications, the level of visibility of the cameras is not of great concern. However, there are some situations where it may not be desired to advertise the fact that a vehicle is capturing imagery data. Additionally, in such conventional designs, certain perspective views are not provided because the cameras are mounted in a ball-like configuration.

Given the need to discreetly capture High Definition (HD), Standard Definition (SD) or Infra-Red (IR) imagery data, certain embodiments of the disclosure provide a system that addresses some or all of the problems that exist with previous camera implementations, as discussed above. Additionally, certain embodiments of the disclosure provide an enhanced perspective.

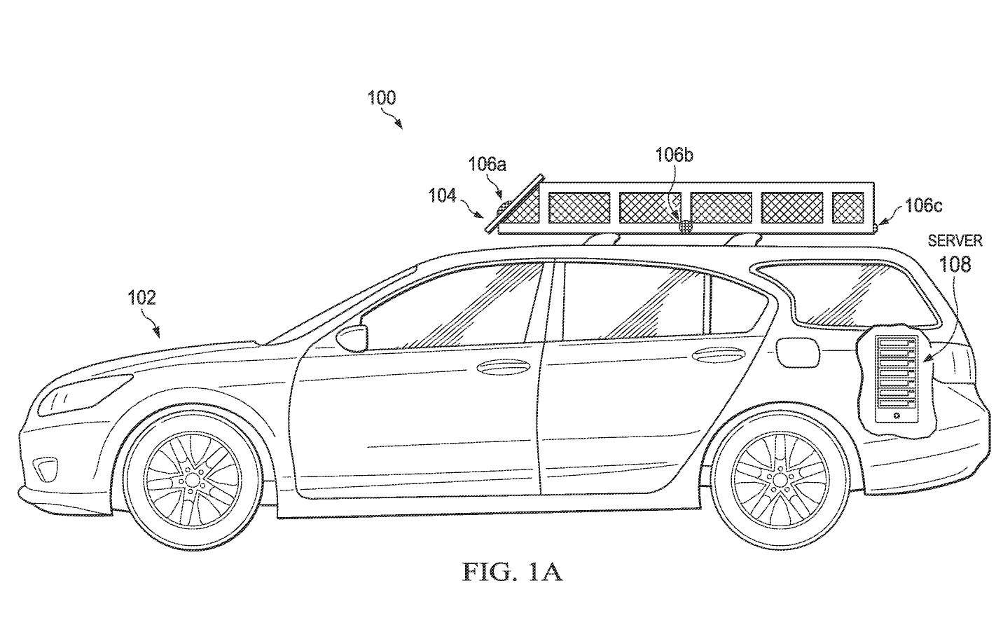

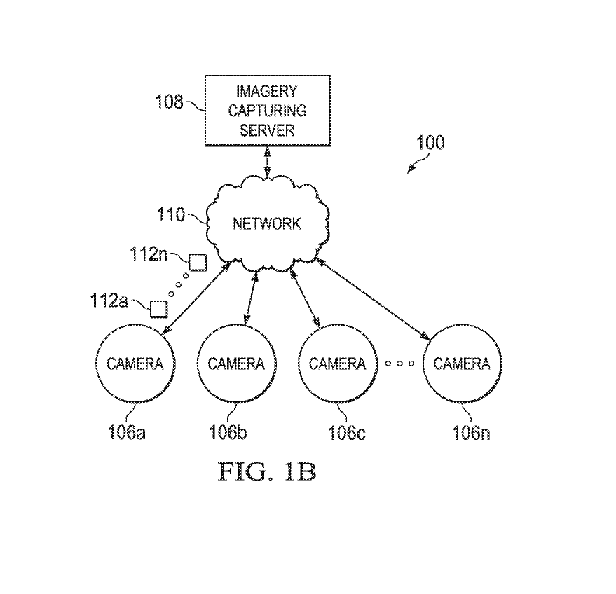

FIG. 1A is a drawing illustrative of one embodiment of a system 100 for discreetly collecting HD, SD, or IR panoramic imagery. The system 100 may be installed in and/or on any vehicle 102 in which a roof rack 104 or similar device may be attached. In one embodiment, the roof rack 104 includes a plurality of cameras 106a-106c (collectively 106) that are distributed and mounted at strategic points, on or embedded within the roof rack 104. The cameras 106 may communicate in a number of ways with an imagery capturing server 108 in communication with each of the cameras, as described in greater detail below,

While the imagery capturing server 108 is depicted as being contained within the vehicle 102, the imagery capturing server 108 may be located anywhere, as long as data captured by the cameras 106 can be communicated to the server 108. Communication between the cameras 106 and the server 108 may occur in real time or near real time; after a run to capture data has been completed; or any number of suitable ways. In addition, although the imagery capturing server 108 generally appears as being in a single location, the imagery capturing server 108 may be geographically dispersed, for example, in cloud computing scenarios,

FIG. 1B is a simplified block diagram of one embodiment of an imagery capturing system 100 that may be utilized by various embodiments of the disclosure. In one embodiment, one or more cameras 106 may be in communication with the imagery capturing server 108 over a network 110. The imagery capturing server 108 may be a high-end small PC or laptop with a capture card or may be any other type of computing device configured to receive imagery data 112a-112n, collectively 112, from the cameras 106. The network 110 may be wired using IEEE 1394b-800 Mb/s Fire wire, Ethernet, USB, or any other cable suitable for communicating imagery between the cameras 106 and the imagery capturing server 108. In other embodiments, the network 110 may include, but are not limited to, a public or private data network; a local area network (LAN); a metropolitan area network (MAN); a wide area network (WAN); a wireline or wireless network (GSM, CDMA, LTE, WIMAX, or the like); a local, regional, or global communication network; portions of a cloud-computing network; a communication bus for components in a system; an optical network; a satellite network; an enterprise intranet; other suitable communication links; or any combination of the preceding. In particular embodiments, portions of the network 110 may be on the Internet. In other embodiments, portions may not be on the Internet.

In one embodiment, imagery data 112 may include any combination of images, video, GPS coordinates and metadata, camera direction (e.g., compass) and angle information, geotag information, as well as any other information the cameras 106 may collect. In certain embodiments, the imagery data 112 can be infrared data or thermal imaging data. In other embodiments, the imagery data 112 can include color, intensity and direction of light impinged upon a digital image sensor in the cameras 106, for example, to allow later modification of a focus for a visual image. The cameras 106 can include any suitable components for capturing such imagery data 112, including any of a variety of sensors including, but not limited to, image and/or light sensors, compass, accelerometers, and a GPS sensor. In other embodiments, a sensor (not expressly shown) may collect data for or on behalf of a plurality of cameras 106, for example, GPS data and/or compass data with such sensor collected. This additional sensor collected data may be communicated as imagery data 112 or may be combined with imagery data 112 according to different embodiments.

In one embodiment, the imagery capturing server 108 is located remotely from the vehicle 102. In embodiments where the imagery capturing server 108 is located remotely, the cameras 106 may store data internally for later transmission, or may wirelessly transmit the data as it is captured to the imagery capturing server 108, which may be wirelessly in communication with the cameras 106. Additional embodiments are described in greater detail below.

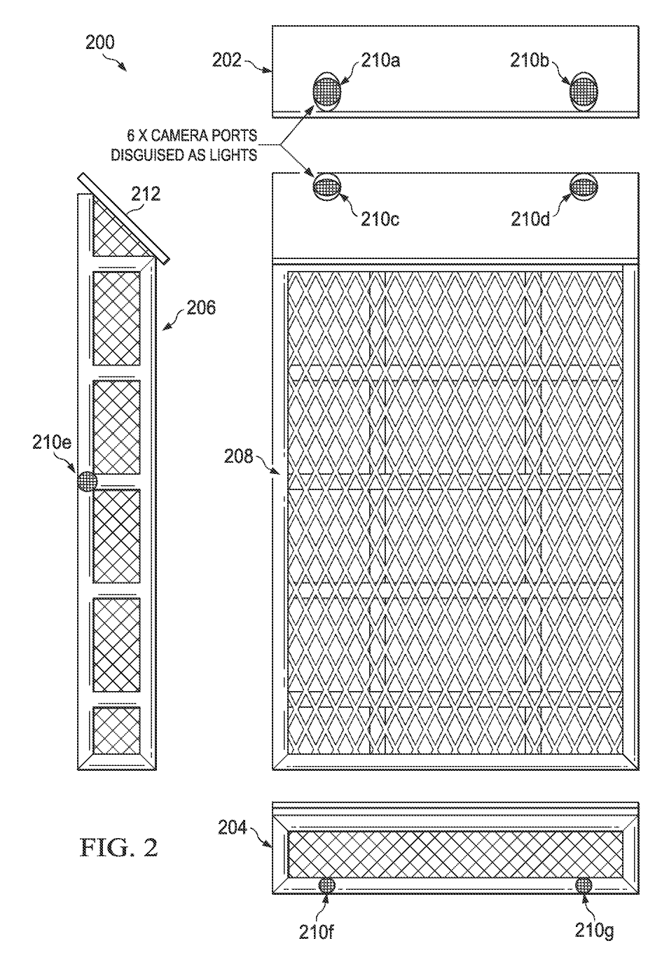

FIG. 2 is a simplified diagram of one embodiment of the exterior of a vehicle roof rack 200 configured to carry out discreet capturing of 3D immersive HD, SD, or IR panoramic imagery that may be utilized by various embodiments of the disclosure. Different surfaces of the roof rack 200 are laid out individually in the depiction. The front surface 202, rear surface 204, side surface 206, and top surface 208 each include cameras 210a-210g (collectively 210), which are mounted on or embedded within the various surfaces of the roof rack 200. In one embodiment, the cameras 210 are concealed within housing or ports to appear as lights, rather than cameras. The side surface 206 depicts a windscreen plate 212 for use in one embodiment for deflecting wind from the roof rack 200.

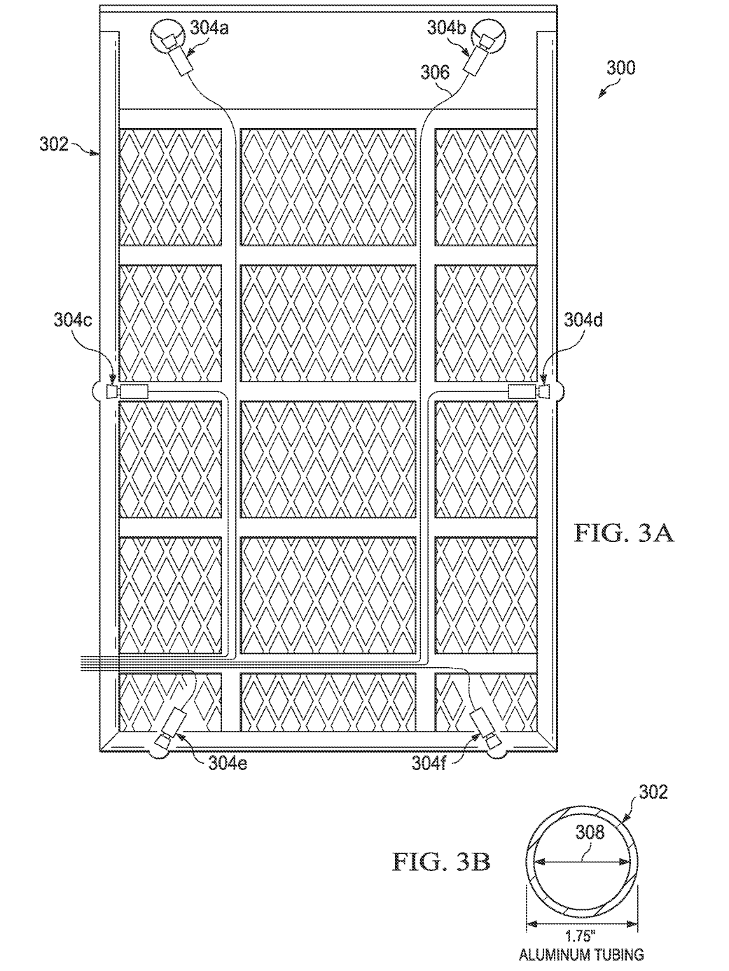

FIG. 3A is a simplified diagram of one embodiment of the interior of a vehicle roof rack 300 configured to provide for the discreet capturing of imagery, which may be utilized by various embodiments of the disclosure. The roof rack 300 may be made out of any suitable material, and in one embodiment, the frame tubing 302 is made out of aluminum, It may also be made out of plastic, fiberglass or other suitable materials. Also depicted in this embodiment are cameras 304a-304f, (collectively cameras 304), which are positioned around the frame tubing 302 in order to carry out embodiments of the present disclosure. The cameras 304 may be connected using wiring 306, such as the wiring discussed above. In addition to wiring 306 for transmitting the images and other data, wiring 306 may alternatively provide power to the cameras 304, depending upon the particular embodiment. The wiring 306 may be concealed within the frame tubing 302, or fixed to the frame tubing 302. In other embodiments, there may not be any wiring 306, rather the cameras 304 may utilize one of the wireless protocols previously described or may be powered using battery power or another power source which does not require a power line. Other non-limiting examples of power sources not requiring a power line include wireless power or techniques that employ wireless energy transmission such as, but not limited to, inductive coupling and resonance techniques.

FIG. 3B is a diagram of the cross section of frame tubing 302 used in a vehicle roof rack operable to carry out discreet capturing of imagery, which may be utilized by various embodiments of the disclosure. The frame tubing 302 may include an interior cavity 308 where wiring 306 may be concealed for connecting the cameras 304 to the imagery capturing server 108 (from FIG. 1) or to a power supply (not shown).

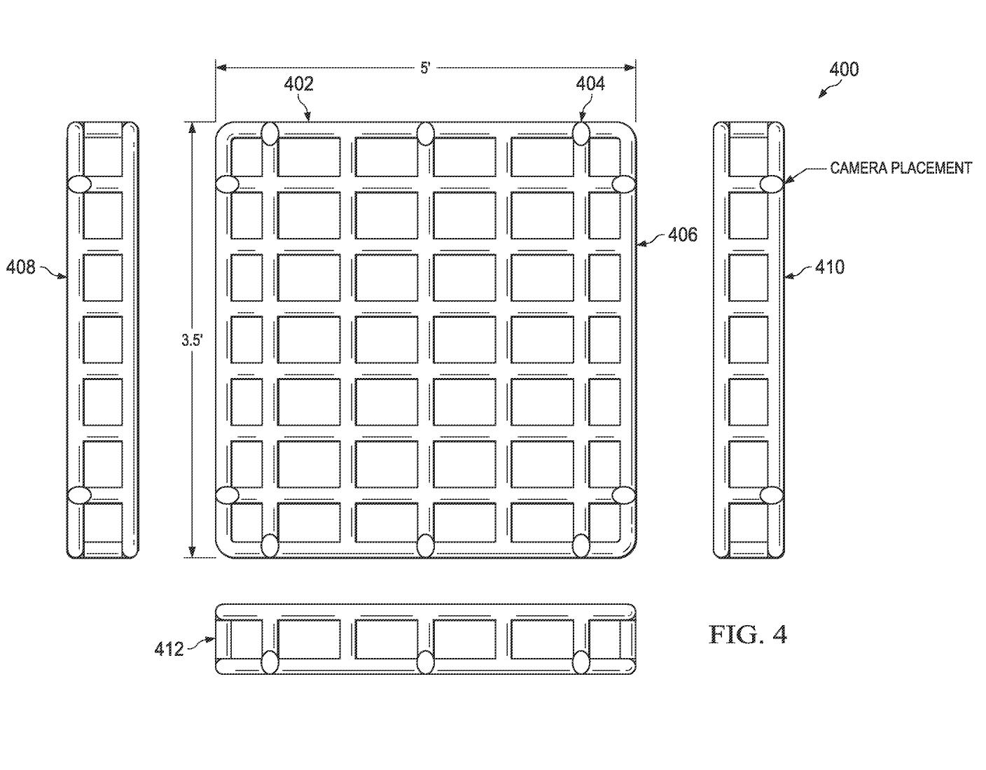

FIG. 4 is an additional depiction of a roof rack 400 that may be utilized by various embodiments of the disclosure. Similar to previous figures, the frame tubing 402 includes camera ports 404 along the top surface 406 of the roof rack 400 for integrating cameras into the roof rack 400. In this embodiment, cameras are placed in a different configuration than in previous embodiments. This placement allows for different imagery to be captured, depending upon the viewing angle of cameras placed in the various camera ports 404. FIG. 4 additionally depicts the front surface 408 of the roof rack 400, the rear surface 410, and the side surface 412. Each of the surfaces depicted provides indications of where cameras may be placed along the surface.

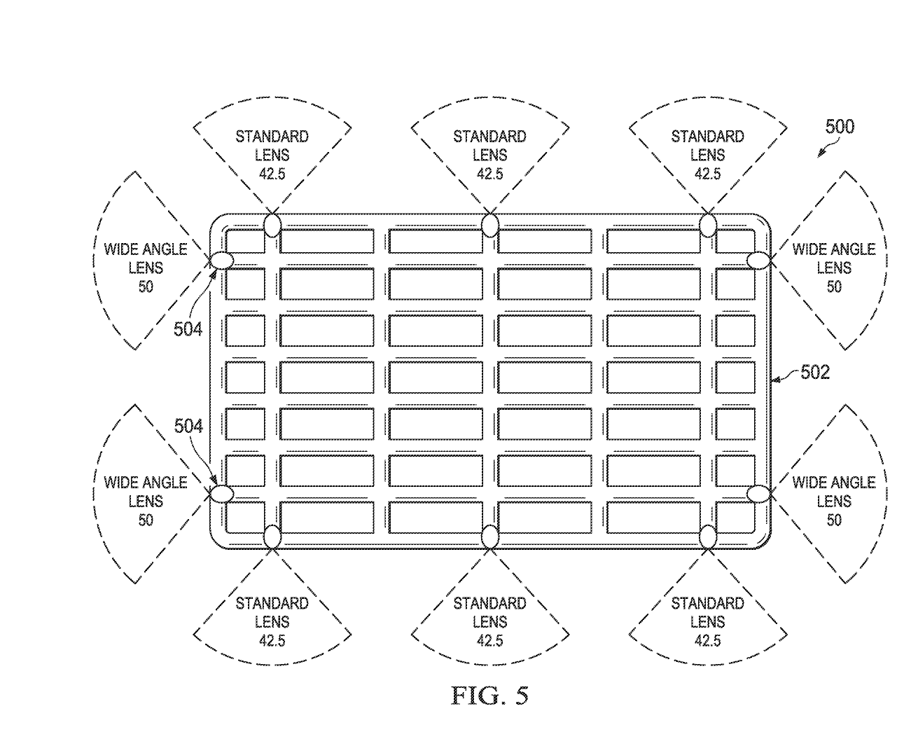

FIG. 5 illustrates an angle of view depiction 500 of an imagery capturing system, according to an embodiment of the disclosure. In one embodiment, various cameras 504 are placed, mounted, embedded or distributed around the roof rack 502, as described in previous figures. Rather than using the same camera or camera lens for each location, cameras or lenses with various angles may be used. In FIG. 5, the side portions of the roof rack show standard lens having a viewing angle of 42.5 degrees, while the front and rear have wide angle lens having a viewing angle of 50 degrees. In other embodiments, other viewing angles for cameras may be utilized. Any combination of cameras may be used depending upon the positions of the cameras 504 in an embodiment. In one embodiment, using imagery from each of the cameras 504, a combined panoramic image may be formed, for example, by stitching together data from multiple cameras. When the data from all the cameras are combined, the panaromic view is 360 degrees.

In addition to the above 360 degree panaromic view, as seen in FIG. 5, the fields of views overlap—yielding different perspective angles. In particular, in this embodiment, the cameras on a particular side are laterally offset with respect to one another. This configuration allows multiple perspective of an object to be viewed. For example, looking at the overlap shown between any two laterally offset cameras, one can see that through one camera the overlap portion is seen from one angle and through another camera the overlap portion is simultaneously seen from another angle. Such overlapping, according to particular embodiments, provides three-dimension depth perspective of objects captured by the. To enhance such three-dimensional depth perception, according to particular embodiments, a host of cameras may be positioned at angles other than directly outward. Additionally, cameras may be stacked on top of one another at similar or different angles.

Although a certain number of cameras are shown in this embodiment, in other embodiments, many more cameras may be utilized. Additionally, in particular embodiments, the cameras may be positioned to move such that they can shoot at different angles.

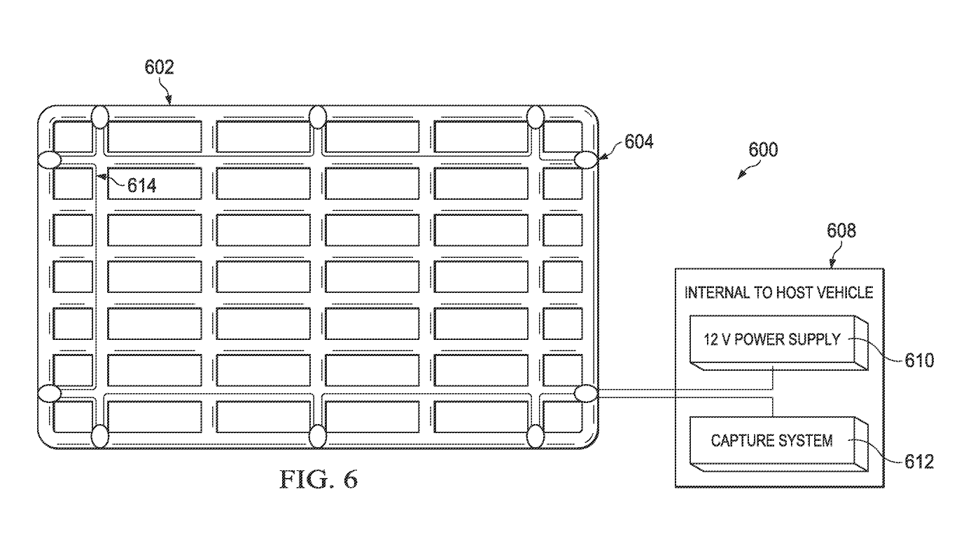

FIG. 6 illustrates a wiring system layout 600 of one embodiment of an imagery capturing system, according to an embodiment of the disclosure. In one embodiment, a roof rack 602 may have a series of cameras 604 connected to a computing device 608, The computing device 608 may be internal to a host vehicle in which the roof rack 602 is mounted or may be located remotely, as previously described. The computing device may include an imagery capture system 612 as well as a power supply 610 for powering the imagery capture system 612. In one embodiment, the capture system 612 is configured to hold 4 to 24 hours of imagery data, including corresponding GPS metadata pairing information and any other metadata. In other embodiments, the capture system 612 may hold more than 24 hours of imagery data, including corresponding GPS metadata pairing information and any other metadata.

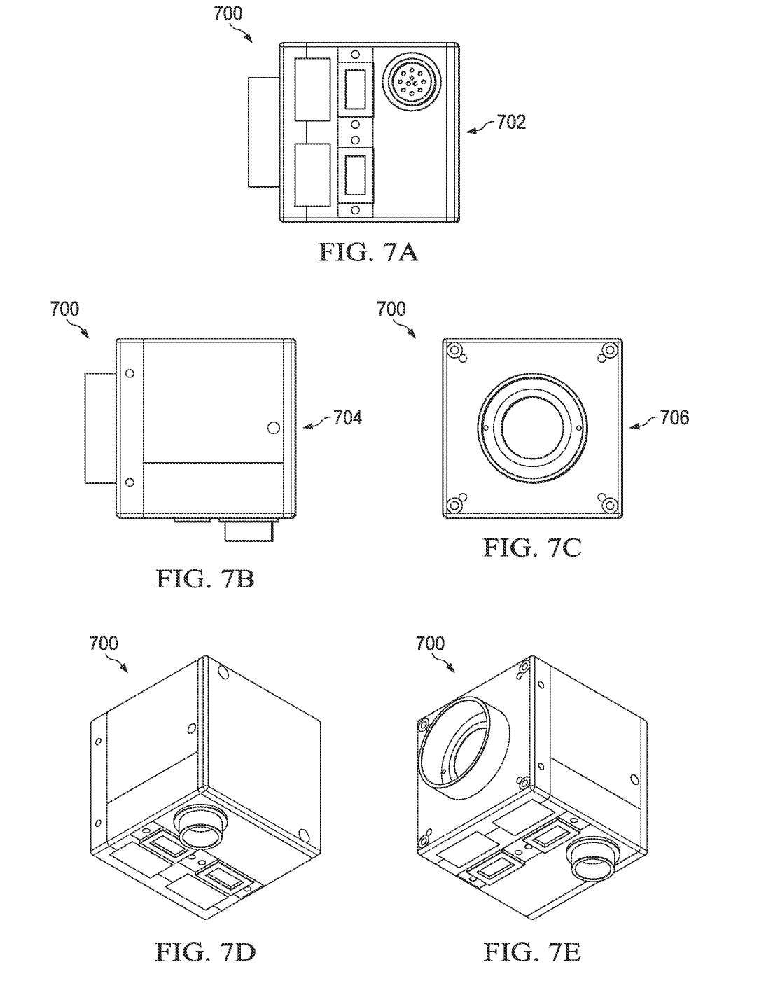

FIG. 7 is a depiction of various angles of a camera 700 and the camera's housing for use in one embodiment of an imagery capturing system, according to an embodiment of the disclosure. In one embodiment, the camera 700 is a Stingray Compact camera using 2 IEEE 1394b (Firewire) connections to communicate with an imagery capture system (not shown). The camera 700 is capable of 2452×2056 resolution, as well as capturing 9 frames per second at full resolution. The cameras 700 are also capable of vehicle and facial recognition from 15 to 30 feet away. Various views 702, 704, and 706 of the camera 700 and its housing are additionally depicted. It should be understood that any camera may be used, depending upon the particular embodiment, and the described camera is just one example.

As a non-limiting example, in other embodiments, the frame rate of other cameras may be more than or less than nine frames per second. In particular embodiments, the frame rate may be so high that it is considered video. Additionally, in particular embodiments, the frame rate may depend on a speed of a vehicle in which the camera is located—dynamically adjusting to faster rates as speed increases and/or slower rates as the speed decreases. he speed of the vehicle may be determined from sensors mounted to the vehicle (e.g., GPS or accelerometers). Alternatively, the imagery capture system may be tied into the controls of the vehicle.

As another non-limiting example, the camera can be of the type marketed under the Lytro brand, which utilize a digital image sensor to capture the color, intensity, and direction of light entering the camera. Using all this collected data, the focus of an image can be dynamically updated during viewing of the image. Thus, for example, the details of both near and far objects are captured. Additionally, such light capturing devices allows a slight shift of perspective, which enhances the perspective techniques disclosed above.

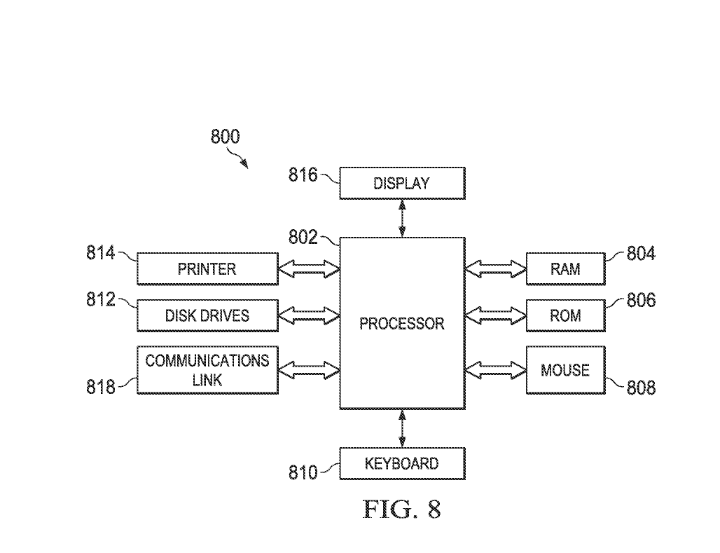

FIG. 8 is an embodiment of a computing device 800 that may be used in connection with other embodiments of the disclosure to carry out any of the above-referenced functions and/or serve as a computing device 800 for processing and storing imagery and related data captured by the system. The computing device 800 may generally be adapted to execute any of the known OS2, UNIX, Mac-OS, Linux, Android and/or Windows Operating Systems or other operating systems. The computing device 800 in this embodiment includes a processor 802, a random access memory (RAM) 804, a read only memory (ROM) 806, a mouse 808, a keyboard 810 and input/output devices such as a printer 814, disk drives 812, a display 816 and a communications link 818. In other embodiments, the computing device 800 may include more, less, or other component parts. Embodiments of the present disclosure may include programs that may be stored in the RAM 804, the ROM 806 or the disk drives 812 and may be executed by the processor 802 in order to carry out functions described herein. The communications link 818 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; a cellular network; an enterprise intranet; Bluetooth™; other suitable communication links; or any combination of the preceding. Disk drives 812 may include a variety of types of storage media such as, for example, solid state drives, floppy disk drives, hard disk drives, CD ROM drives, DVD ROM drives, magnetic tape drives or other suitable storage media, Although this embodiment employs a plurality of disk drives 812, a single disk drive 812 may be used without departing from the scope of the disclosure.

Although FIG. 8 provides one embodiment of a computing device 800 that may be utilized with other embodiments of the disclosure, such other embodiments may additionally utilize computers other than computing device 800 as well as computing devices without conventional operating systems. Additionally, embodiments of the disclosure may also employ multiple computing devices 800 or other computers networked together in a computer network. Most commonly, multiple computing devices 800 or other computers may be networked through the Internet and/or in a client server network. Embodiments of the disclosure may also be used with a combination of separate computer networks each linked together by a private or a public network.

Several embodiments of the disclosure may include logic contained within a physical storage medium. In the embodiment of FIG. 8, the logic includes computer software executable on the computing device 800. The medium may include the RAM 804, the ROM 806, the disk drives 812, or other mediums. In other embodiments, the logic may be contained within hardware configuration or a combination of software and hardware configurations.

The logic may also be embedded within any other suitable medium without departing from the scope of the disclosure.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for discretely capturing data, the system comprising
a concealing structure;
two or more cameras hidden within the concealing structure, the two or more cameras each having one or more sensors configured to collect imagery data, the imagery data including data configured to construct one or more images.

2. The system of claim 1, wherein one image is constructed of data from at least two of the two or more cameras.

3. The system of claim 2, wherein the one image is a panoramic image.

4. The system of claim 1, wherein the two or more cameras is more than two cameras that yield a 360 degree panoramic image when imagery data from the more than two cameras is stitched together.

5. The system of claim 1, wherein at least two of the two or more cameras are laterally offset from one another.

6. The system of claim 4, wherein the laterally offset cameras have an overlapping field of view that is configured to simultaneously view an object from different perspectives, the different perspectives yielding a depth perception.

7. The system of claim 1, further comprising:
a server configured to receive the imagery data from the from the two or more cameras hidden within the concealing structure.

8. The system of claim 7, wherein the server wirelessly receives the imagery data from the cameras hidden within the concealing structure.

9. The system of claim 1, wherein the concealing structure is a feature of a vehicle.

10. The system of claim 9, wherein the concealing structure is a roof rack of a vehicle.

11. The system of claim 1, wherein at least one of the two or more cameras has a modifiable frame rate.

12. The system of claim 11, wherein the frame rate for the at least one of the two or more cameras is modified based on a speed at least one of the two or more cameras.

13. The system of claim 1, wherein the two or more cameras include at least one camera with a first field of a view and at least a second camera with a second field of view, and the first field of view is different than the second field of view.

14. A system for capturing image data, the system comprising a plurality of cameras that are laterally offset from one another, each of the cameras having one or more sensors configured to collect imagery data, the imagery data including data configured to construct one or more images.

15. The system of claim 14, wherein one image is constructed of data from at least two of the plurality of cameras.

16. The system of claim 15, wherein the one image is a panoramic image.

17. The system of claim 14, further comprising:
a second a plurality of cameras that are laterally offset from one another, each of the cameras having one or more sensors configured to collect imagery data, the imagery data including data configured to construct one or more images; and
wherein the plurality of cameras and the second plurality of camera yield a 360 degree panoramic image when imagery data from the plurality of cameras and the second plurality of camera is stitched together.

18. The system of claim 14, wherein the plurality of cameras are mounted to a vehicle.

19. The system of claim 14, wherein the plurality of cameras that are laterally offset from one another is three or more cameras.

20. The system of claim 14, further comprising:
three additional sets of a plurality of cameras that are laterally offset from one another, each of the cameras in each of the sets having one or more sensors configured to collect imagery data, the imagery data including data configured to construct one or more images.
